(19) United States
(12) Patent Application Publication
(10) Pub. No.: US 2019/0210480 A1
(43) Pub. Date: Jul. 11, 2019

(54) Wireless Charging Alignment Systems

(71) Applicant: Apple Inc., Cupertino, CA (US)

(72) Inventors: Jeffrey M. Alves, Pleasanton, CA (US); Zaka Ullah Zahid, Sunnyvale, CA (US); Jennifer D. Pollock, Palo Alto, CA (US); Derryk C. Davis, Campbell, CA (US); Hunter H. Wu, San Jose, CA (US)

(21) Appl. No.: 16/357,089

(22) Filed: Mar. 18, 2019

Related U.S. Application Data
(63) Continuation of application No. 16/326,085, filed on Feb. 15, 2019, now abandoned.
(60) Provisional application No. 62/375,660, filed on Aug. 16, 2016.

(51) Int. Cl. B60L 53/36; H02J 50/90; H02J 50/60; H02J 50/10; H02J 7/02; B60L 53/12

(52) U.S. Cl. CPC B60L 53/36; H02J 50/90; B60L 53/12; H02J 50/10; H02J 7/025; H02J 50/60

(57) ABSTRACT

A system such as a vehicle may have control circuitry that controls a steering and propulsion system. The control circuitry may use the steering and propulsion system to park the vehicle in a parking space. Wireless power may be transferred from a wireless power transmitter in the parking space to a wireless power receiver coupled to a vehicle body in the vehicle. The control circuitry may use sensors to make sensor measurements during parking events. The control circuitry may also gather information on wireless power transfer efficiency. Historical vehicle-to-wireless-power-transmitter alignment information may be updated based on the sensor measurements and corresponding wireless power transfer efficiency measurements and may be used to park the vehicle in an optimal location during subsequent parking events. Vehicle parking position may be intentionally varied over a series of parking events to gather additional alignment information.

This application is a continuation of U.S. patent application Ser. No. 16/326,085, filed Feb. 15, 2019, which claims priority to U.S. provisional Patent Application Ser. No. 62/375,660, filed Aug. 16, 2018, which are hereby incorporated by reference herein in their entireties.

### FIELD

This relates generally to wireless charging, and, more particularly, to wireless charging of vehicles.

### BACKGROUND

A battery in an electric vehicle can be charged by plugging a charging cable into a charging port of the vehicle. It would be less cumbersome to be able to transfer power wirelessly from a charging pad located on the ground and a corresponding wireless power receiver mounted to the underside of a vehicle. While avoiding the need to use charging cables, wireless charging approaches may face challenges in transferring power efficiently. If care is not taken, the wireless power receiver in a vehicle will be misaligned with the charging pad and efficiency will suffer.

### SUMMARY

It would therefore be desirable to be able to provide improved wireless charging arrangements for vehicles. A system such as a vehicle may have control circuitry that controls a steering and propulsion system. The control circuitry may use the steering and propulsion system to park the vehicle in a parking space. Wireless power may be transferred from a wireless power transmitter in the parking space to a wireless power receiver coupled to a vehicle body in the vehicle.

The control circuitry may use sensors to make sensor measurements during parking events. The control circuitry may also gather information on wireless power transfer efficiency. Historical vehicle-to-wireless-power-transmitter alignment information may be updated based on the sensor measurements and corresponding wireless power transfer efficiency measurements. During subsequent parking events, the historical vehicle-to-wireless-power-transmitter alignment information may be used to park the vehicle in a location with maximum wireless power transfer efficiency. If desired, the position at which a vehicle is parked within a parking space may be intentionally varied over a series of parking events to gather additional alignment information.

### BRIEF DESCRIPTION OF THE DRAWINGS

FIG. 1 is a schematic diagram of an illustrative system in accordance with an embodiment.

FIG. 2 is a cross-sectional side view of illustrative wireless power transmitter and wireless power receiver components and associated foreign object detection coil arrays that may serve as foreign object sensors in accordance with an embodiment.

FIG. 3 is a diagram of an illustrative camera-based alignment system in accordance with an embodiment.

FIG. 4 is a diagram of an illustrative range finding system in accordance with an embodiment.

FIG. 5 is a diagram of an illustrative magnetic sensor system in accordance with an embodiment.

FIG. 6 is a diagram of an illustrative acoustic sensing system in accordance with an embodiment.

FIG. 7 is a diagram of an illustrative sensing system in which a detector on a vehicle monitors emitted signals from an emitter in a parking space in accordance with an embodiment.

FIG. 8 is a diagram of an illustrative mechanical sensor system in accordance with an embodiment.

FIG. 9 is a diagram showing how a vehicle may be parked within a parking space so that a wireless power receiver on the vehicle may be aligned with a wireless power transmitter in the parking space in accordance with an embodiment.

FIG. 10 is a graph showing how sensor measurements may be correlated with wireless power transfer efficiency across various different relative vehicle-to-wireless-power-transmitter positions in accordance with an embodiment.

FIG. 11 is a diagram of an illustrative one-dimensional path that a vehicle may take when parking to align a wireless power receiver with a wireless power transmitter in accordance with an embodiment.

FIG. 12 is a diagram of an illustrative a two-dimensional search path that may be taken by a vehicle when parking to align a wireless power receiver in the vehicle with a wireless power transmitter in a parking space in accordance with an embodiment.

FIG. 13 is a graph showing how a vehicle may be parked in a variety of different locations within a parking space over a series of different parking events while making sensor measurements and wireless power transfer efficiency measurements to gather wireless-power-receiver-to-wireless-power-transmitter alignment information in accordance with an embodiment.

FIG. 14 is a graph showing how wireless power transfer efficiency gains may be achieved over time and how the aggressiveness of a search for optimum vehicle-to-wireless-power-transmitter alignment may be reduced over time in accordance with an embodiment.

FIG. 15 is a flow chart of illustrative operations associated with maneuvering a vehicle to align a wireless power receiver in the vehicle to a wireless power transmitter associated with a parking space in accordance with an embodiment.

### DETAILED DESCRIPTION

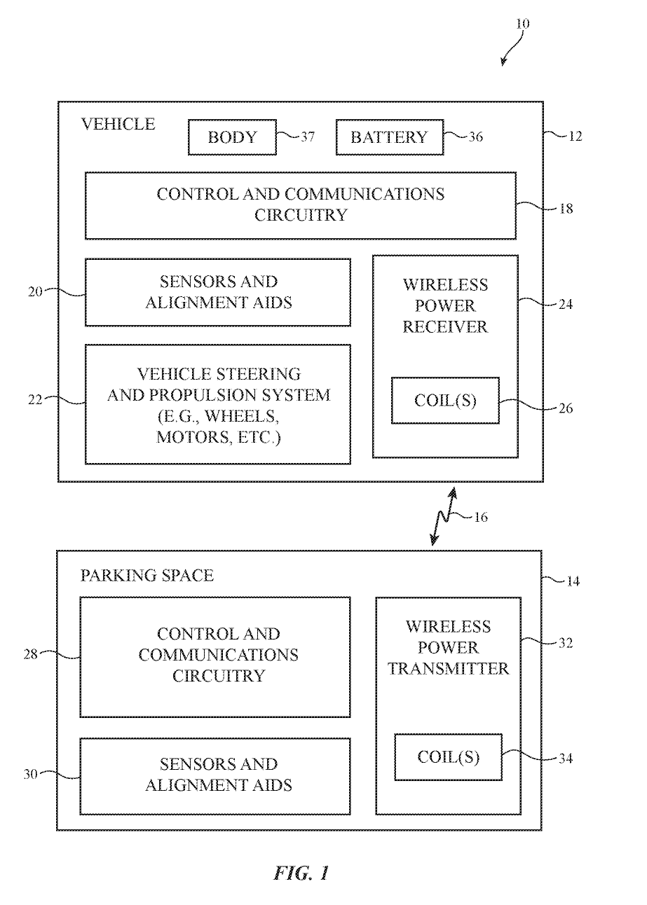

An illustrative vehicle charging system is shown in FIG. 1. As shown in FIG. 1, system 10 may include wireless charging equipment such as wireless power transmitter 32 at parking space 14. Wireless power transmitter 32 may have one or more coils 34 that transmit wireless power (see, e.g., wireless signals 16) in the form of alternating-current electromagnetic fields that are received by one or more coils 26 in a corresponding wireless power receiver 24 in vehicle 12. Control and communications circuitry 28 may be associated with parking space 14 and may control the operation wireless power transmitter 32. Sensors and alignment aids 30 may be used with sensors and alignment aids 20 in vehicle 12 to gather information that helps vehicle 12 park in parking space 14 so that wireless power receiver 24 (e.g., coil(s) 26) is well aligned with wireless power transmitter 32 (e.g., coil(s) 34). This allows wireless power transfer efficiency (the efficiency with which wireless power is transmitted to vehicle 12 and received by vehicle 12) for wireless power transfer operations between transmitter 32 and receiver 24 to be enhanced.

Sensors and alignment aids 20 of vehicle 12 may operate in conjunction with sensors and alignment aids 30 in parking space 14. As an example, sensors and alignment aids 30 of parking space 14 may contain visual alignment marks and sensors and alignment aids 20 may contain a camera (e.g., a digital image sensor and lens) that captures and processes images of the alignment marks to assist with aligning receiver 24 and transmitter 32.

Vehicle 12 may include vehicle steering and propulsion system 22. System 22 may include, for example, electrically controlled motors coupled to the wheels of vehicle 12 to move vehicle 12 forward and backward, an electrically controlled steering system that steers vehicle 12, and other vehicle systems. If desired, system 22 may include inertial measurement units that include accelerometers, magnetic sensors (compasses), and/or gyroscopes for monitoring vehicle motion and position. System 22 may include wheel sensors such as sensors that measure the rotation of the wheels of vehicle 12 to determine vehicle position relative to surface on which vehicle 12 is driving, wheel velocity sensors that measure wheel speed to monitor vehicle motion, velocity sensors such as laser-based or radio-frequency-based Doppler velocity sensors, and/or other sensors for monitoring vehicle location, speed, and/or acceleration relative to the surrounding environment. Global Positioning System (GPS) circuitry or other satellite navigation system circuitry (e.g., a satellite navigation system receiver) may also be used in measuring position, speed, etc. Using components such as these, system 22 can accurately measure vehicle movement (e.g., vehicle position, vehicle velocity, and/or vehicle acceleration).

Vehicle 12 may include control and communications circuitry 18. Control and communications circuitry 18 and control and communications circuitry 28 may include microprocessors, digital signal processors, microcontrollers, application-specific integrated circuits, storage such as hard drive storage, volatile and non-volatile memory, solid state drives, and other circuitry (e.g., integrated circuits, etc.) for executing code and performing desired operations for system 10. For example, control and communications circuitry 18 can be used to autonomously maneuver vehicle 12 on roadways and in parking spaces such as parking space 14. Control and communications circuitry 18 may also include input-output devices (e.g., steering wheels, displays, speakers, microphones, buttons, floor pedals, etc.) for receiving user input (e.g., driving commands for parking etc.) and for providing a user with output (e.g., driving instructions for parking, etc.).

Illustrative configurations in which vehicle 12 uses control and communications circuitry 18 to control the operation of vehicle steering and propulsion system 22 so that vehicle 12 can be parked in various locations within parking space 14 may sometimes be described herein as an example. In general, vehicle 12 may be manually driven while control and communications circuitry 18 provides a driver with driving instructions (e.g., position feedback, etc.) and/or may be autonomously maneuvered (e.g., parked while a user is not touching the steering wheel, while a user is not controlling steering, while a user is only controlling speed by braking, while a user is not controlling steering or propulsion except for emergencies, and/or while control and communications circuitry 18 is otherwise autonomously controlling operation of vehicle 12).

Control and communications circuitry 18 of vehicle 12 may communicate wirelessly with control and communications circuitry 28. Circuitry 28 may be associated with parking space 14 (e.g., there may be control circuitry such as circuitry 28 at each parking space, there may be shared control circuitry such as circuitry 28 that is associated with multiple parking spaces such as the parking spaces in a parking garage, there may be control circuitry such as circuitry 28 that communicates with sensors and alignment aids 30 and/or wireless power transmitter 32 via the internet or other communications network, and/or there may be other circuitry associated with parking space 14.

Vehicle 12 may obtain power from an internal combustion engine and from a battery such as battery 36. Vehicle 12 may, for example, obtain power exclusively from battery 36 and may use electrical motors in system 22 to maneuver vehicle 12. The components of vehicle 12 such as battery 36, control and communications circuitry 18, sensors and alignment aids 20, wireless power receiver 24, and vehicle steering and propulsion system 22 may be coupled to (e.g., mounted to) vehicle body 37. As used herein, vehicle body refers to any structure of a vehicle, including exterior and interior panels, chassis structures, underbody, glass, so forth.

During operation of vehicle 12, vehicle 12 may use power from battery 36 to power vehicle 12. When battery 36 becomes depleted, battery 36 may be recharged by parking vehicle 12 (vehicle body 37) in parking space 14 so that wireless power transmitter 32 may wirelessly transmit power to wireless power receiver 24. Visual aids (e.g., visual fiducials making the location of wireless power transmitter 32) and other parking aids may be used in determining how to position vehicle 12 within parking space 14 so that wireless power transmitter 32 and wireless power receiver 24 are aligned.

When wireless power transmitter 32 and wireless power receiver 24 are misaligned, the efficiency with which wireless power transmitter 32 transmits wireless power to wireless power receiver 24 will be degraded. Maximum wireless power transfer efficiency can be achieved by placing vehicle 12 in an optimal position within parking space 14. For example, control and communications circuitry 18 may visually and/or audibly assist a user in positioning vehicle 12 in this optimal position or control and communications circuitry 18 may autonomously (with optional user overrides) use vehicle steering and propulsion system 22 to position vehicle 12 in this optimal position.

Due to variations between vehicles and variations between the equipment at different parking spaces, it can be challenging to identify an optimal parking position for vehicle 12. For example, if vehicle 12 were to only use visual alignment techniques to align receiver 24 to transmitter 32, there would be a risk that manufacturing variations in vehicle 12 and/or the equipment of parking space 14 would cause receiver 24 and transmitter 32 to be somewhat misaligned, even in situations in which measurements made by visual alignment equipment in system 10 indicate that optimal alignment has been achieved.

To overcome these challenges, vehicle 12 can gather wireless power transfer performance information from system 10 over a period of time using vehicle parking positions that are intentionally each offset with respect to a nominally optimal parking position. The information that is gathered may include information from alignment system sensors and associated information on wireless power transfer efficiency. Using this information, which may sometimes be referred to as vehicle-to-wireless-power-transmitter alignment information, vehicle 12 can correlate measured variations in wireless power transfer efficiency with sensor measurements indicative of the relative position between receiver 24 and transmitter 32. Once sufficient historical vehicle-to-wireless-power-transmitter alignment information has been gathered, vehicle 12 will be able to identify optimal sensor readings associated with the optimal position for vehicle 12 within parking space 14 to maximize wireless power transfer efficiency (e.g., control circuitry 18 may use the historical vehicle-to-wireless-power-transmitter alignment information to determine where to position vehicle 12 in space 14 so that the efficiency with which power is transferred from transmitter 32 to receiver 24 is maximized).

The location of a parking space and the transmitter 32 associated with that space can be represented using a geographic coordinate or other location information. Alignment information (e.g., historical vehicle-to-wireless-power-transmitter alignment information) associated with the relative position between vehicle 12 (receiver 24) and transmitter 32 (and the parking space containing transmitter 32) can be represented using a position offset (e.g., offset information such as a position offset in a geographic coordinate system and/or other offset information). The historical vehicle-to-wireless-power-transmitter alignment information that is gathered by vehicle 12 during operation of vehicle 12 includes wireless power transfer efficiency information for various offsets, where each offset represents a different separation (e.g., a distance and an angle or a separation represented in other coordinates) between (i) the location of vehicle 12 at the time of measuring the wireless power transfer efficiency information and (ii) a geographic coordinate or other location information representing the location of transmitter 32 and the parking space in which transmitter 32 is located.

Sensor measurements for determining the relative alignment between receiver 24 and transmitter 32 may be gathered using sensors in vehicle 12 and/or sensors in parking space 14. Wireless communications circuitry (e.g., circuitry 18 and 28) may be used to allow vehicle 12 and parking space 14 to exchange sensor measurements. For example, parking space 14 may make visual measurements of the underside of vehicle 12 and may convey this information to vehicle 12 for vehicle 12 to use in determining relative alignment between receiver 24 and transmitter 32. Other information on alignment can also be conveyed from sensors in parking space 14, if desired.

If desired, vehicle 12 and parking space 14 may communicate when gathering wireless power transfer efficiency measurements. For example, vehicle 12 may determine the wireless power transfer efficiency for system 10 by gathering information on the magnitude of power being received from power receiver 24 and wirelessly querying parking space 14 for information on the magnitude of power being transmitted using transmitter 32. The information gathered on the magnitudes of transmitted and received power may then be used to compute wireless power transfer efficiency.

In general, wireless power transfer efficiency measurements, sensor measurements, updates to historical information, and/or the processing of other information in system 10 may be performed by control and communications circuitry in vehicle 12, by control and communications circuitry associated with parking space 14, and/or by control and communications circuitry associated with cloud-based services (e.g., control and communications circuitry that is coupled to system 10 by a wireless local area network, wide area network, and/or other communications networks). Illustrative configurations in which circuitry 18 in vehicle 12 is used in processing sensor information and wireless power transfer efficiency information to update historical information related to vehicle alignment and wireless power transfer efficiency measurements may sometimes be described herein as an example.

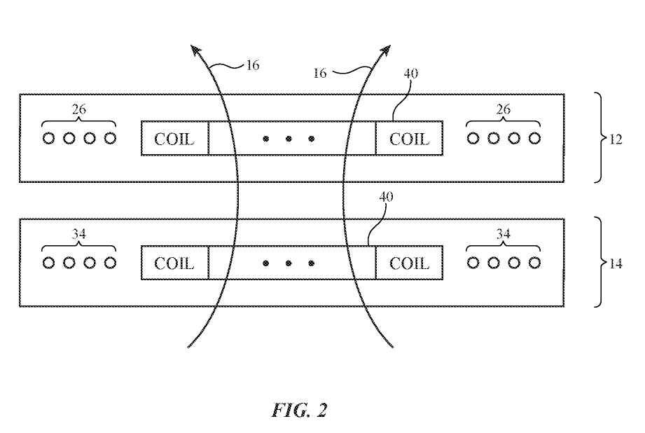

Any suitable sensors may be used for gathering vehicle-to-wireless-power-transmitter alignment information. As shown in the illustrative configuration of FIG. 2, vehicle 12 and/or parking space 14 may be provided with one or more arrays 40 of foreign object detection coils. These coils may operate at lower powers than wireless power transfer coils 34 and 26 and may be used in determining whether or not any foreign objects (e.g., metal objects) are present in the vicinity of coils 34 and 26 before full power wireless power transfer operations are initiated. In addition to serving as foreign object detection sensors, one or more of the coils in an array 40 in vehicle 12 or in parking pace 14 may be used as a magnetic sensor that measures magnetic fields 16 associated with wireless power transfer between coil 34 and coil 26. Using these measurements, the relative alignment between vehicle 12 and parking space 14 and therefore the alignment between coil 26 and coil 32 may be determined. For example, an array 40 of foreign object detection coils in vehicle 12 may be used to measure a field distribution profile for magnetic (electromagnetic) fields 16 that in turn may be used to determine relative alignment between coil 34 (transmitter 32) and coil 26 (receiver 24).

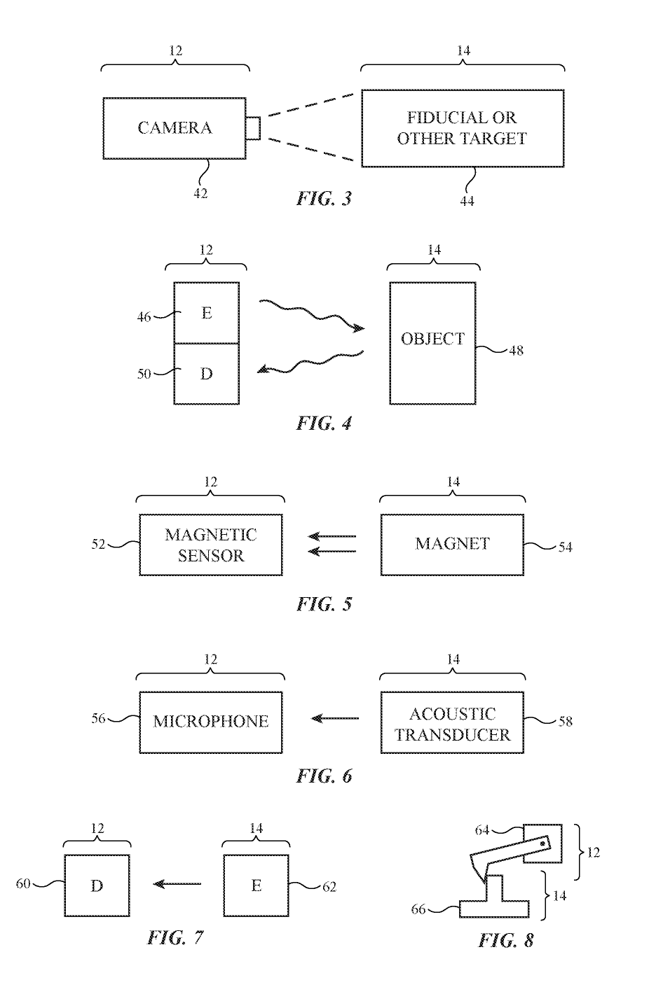

FIGS. 3, 4, 5, 6, 7, and 8 show additional sensors and alignment aids that may be used in vehicle 12 and/or parking space 14 to gather vehicle-to-wireless-power-transmitter alignment information.

In the example of FIG. 3, vehicle 12 has camera 42 and parking space 14 has structures 44 that can be used to aid in alignment (e.g., alignment marks, etc.). Camera 42 may operate at visible light wavelengths (e.g., the alignment marks may be black crosses on white backgrounds on transmitter 32 or the ground or walls surrounding parking space 14), may operate at one or more infrared wavelengths (e.g., so that camera 42 may capture thermal images of heated structures in transmitter 32 such as hot coils 34), may operate at other wavelengths, and/or may gather images of other alignment structures. If desired, images captured by camera 42 may be processed using image processing techniques, so that painted parking space lines, portions of the walls of a garage associated with parking space 14, and/or other visible elements of parking space 14 may be used as alignment features.

In the example of FIG. 4, vehicle 12 includes an emitter 46 that emits signals towards object 48 in parking space 14. Returned (e.g., reflected) signals from object 48 may be detected using detector 50 in vehicle 12. The emitted signals may be light. For example, emitter 46 may be a light-emitting diode, laser, or other light source and detector 50 may be a corresponding light sensor in a light detection and ranging (LIDAR) system. The emitted signals may also be radio-frequency electromagnetic signals (e.g., emitter 46 may be a radio-frequency transmitter and detector 50 may be a radio-frequency detector in a radar system). In a sonar system, emitter 46 may be an acoustic transducer (e.g., a speaker that emits ultrasonic sounds or other sounds) and detector 50 may be a microphone. Using these arrangements or other suitable arrangements, the equipment of FIG. 4 may be used to determine the position of vehicle 12 relative to parking space 14 and thereby gather information on vehicle-to-wireless-power-transmitter alignment.

FIG. 5 shows how parking space 14 may have components such as magnet 54 (e.g., a permanent magnet, a wireless power transmitting coil, a foreign object detection coil, an electromagnet that is separate from the wireless power transmitting and foreign object detection equipment of system 10, etc.) and showing how vehicle 12 may have a corresponding sensor such as magnetic sensor 52 for detecting magnetic fields produced by magnet 54. The sensed magnetic fields (e.g., magnetic field strength measurements) may be used as information on vehicle-to-wireless-power-transmitter alignment. Magnetic measurements may, if desired, be made by using one or more coils such as the coils of array 40 and/or coil 26 as sensor coils for magnetic sensor 52. Magnet 54 may be separate from coil 34 or may be a magnetic structure associated with coil 34. In some configurations, magnet 54 may be an alignment magnet that is mounted in a fixed location with respect to coil 34. If desired, parking space 14 may use a magnetic sensor such as sensor 52 (e.g., a magnetometer, a magnetic sensor that uses coils 40 in parking space 14 and/or coil 34 to sense magnetic fields, etc.) to sense magnetic fields from a permanent magnet mounted in vehicle 12, to sense magnetic fields produced by coil 26 and/or coils 40, and/or to otherwise magnetically sense alignment between vehicle 26 and parking space 14 (e.g., to make magnetic measurements indicative of alignment that are separate from making wireless power efficiency measurements). Using arrangements such as these, magnetic sensors such as stand-alone magnetometers can measure magnetic fields and/or magnetic sensors containing sensor coils such as foreign object detection coils and/or wireless power transfer coils (transmitter and/or receiver coils) can be used for detecting magnetic fields (e.g., magnetic fields from permanent magnets, fields generated by foreign object detection coils and/or wireless power transfer coils and/or other coils in parking space 14 and/or vehicle 12, etc.).

Microphone 56 of vehicle 12 of FIG. 6 may be used to measure sound emitted by acoustic transducer 58 of parking space 14. Acoustic transducer 58 may, for example, be a speaker or other equipment that produces ultrasonic tones. The tones may be emitted continuously or as a series of pulses. The strength and/or timing of these signals as measured by microphone 56 may be used to determine alignment between vehicle 12 and wireless power transmitter 32.

FIG. 7 shows how other types of signal emitters (e.g., emitter 62 of parking space 14) may be used to provide a detector such as detector 60 in vehicle 12 with alignment information. Emitter 62 may be, for example, a light emitter or radio-frequency signal emitter in transmitter 32 or otherwise associated with parking space 14. Detector 60 may be a light sensor that measures reference light signals or a radio-frequency receiver that measures reference radio-frequency transmissions from emitter 62. The strength of these measurements and/or the timing of these measurements may be used to determine how vehicle 12 is positioned relative to wireless power transmitter 32. If desired, vehicle 12 may be provided with a Doppler velocity sensor that is configured to measure the relative speed between vehicle 12 and parking space 14 (e.g., by measuring movement of vehicle 12 relative to parking space 14).

Another way that vehicle alignment with respect to transmitter 32 may be measured is illustrated in FIG. 8. In this example, parking space 14 has a mechanical alignment structure 66 such as a structure with an alignment protrusion at a known location in space 14. The protrusion may, for example, be located on transmitter 32. Vehicle 12 may have a corresponding mechanical measuring device (e.g., a profilometer) that measures the height and location of mechanical alignment structure 66 and thereby determines the relative position between vehicle 12 and wireless power transmitter 32.

These examples of sensor systems that may be used in gathering vehicle-to-wireless-power-transmitter alignment information are merely illustrative. Any suitable systems may be used by vehicle 12 and parking space 14 to measure the position of vehicle 12 and receiver 24 relative to parking space 14 and transmitter 32, if desired.

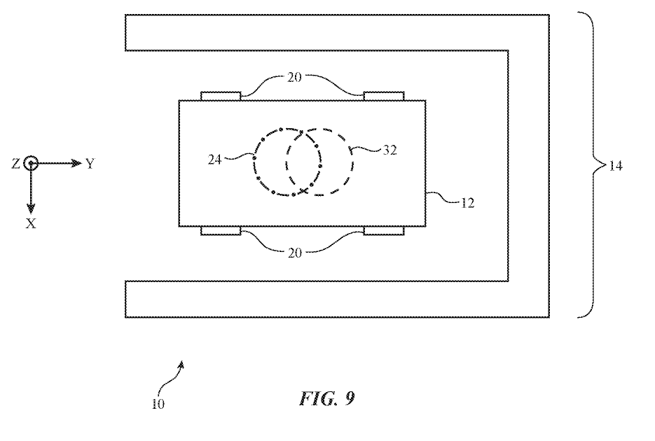

A top view of an illustrative parking space into which a vehicle is being parked is shown in FIG. 9. As shown in FIG. 9, steering and propulsion system 20 (e.g., wheels, motors, steering equipment, etc.) may be used in adjusting the position of vehicle 12 in lateral dimensions X and Y during parking. As an example, wheels system 20 may be used to move vehicle 12 forward in positive direction Y and in reverse in negative direction Y. Dimension Y may be parallel to the longitudinal axis (axis of motion) of vehicle 12. Steering operations may be used to move vehicle 12 to the left or right (e.g., to make adjustment in the position of vehicle 12 relative to the X axis of FIG. 9). If desired, air suspension adjustments and/or adjustments to the vertical position of wireless power receiver 24 and/or wireless power transmitter 32 can be made to help enhance wireless power transfer efficiency (e.g., Z-dimension adjustments). Illustrative configurations in which vehicle 12 is positioned in dimensions X and Y may sometimes be described herein as an example.

As illustrated in FIG. 9, wireless power receiver 24 may not (at least initially) be aligned with wireless power transmitter 32. This can degrade wireless power transmitter efficiency. Although the accuracy of the alignment sensors in system 10 may be relatively high, the individual characteristics of vehicle 12 and parking space 14 may cause receiver 24 to be misaligned with transmitter 32 when nominal optimal alignment settings are used. As an example, consider a system in which the position of the center of coil 34 is marked with a visual alignment mark on the top of transmitter 32. A camera in vehicle 12 may accurately align vehicle 12 and therefore receiver 24 with this alignment mark, but wireless transfer efficiency may still not be as high as desired due to manufacturing variations that resulted in misalignment of coil 34 with respect to the alignment mark or that resulted in the camera of vehicle 12 being misaligned with respect to coil 26 of receiver 24.

To overcome potential alignment inaccuracies due to manufacturing variations, control circuitry 18 of vehicle 12 may park vehicle 12 in a series of different trial locations within parking space 14. Each trial location may be intentionally misaligned (intentionally offset) with respect to the nominal optimal location. For example, each trial location may be located at a different unique position in the XY plane of FIG. 9 with respect to the expected best alignment position (the position at which the camera in vehicle 12 and alignment mark in parking space 14 indicate that vehicle 12 and parking space 14 are optimally aligned). Trial parking locations may be explored over an extended period of time (e.g., over weeks or months) and may involve numerous individual parking events.

To learn successfully from this trial and error approach, vehicle 12 may gather sensor measurements using sensor and alignment aids 20 and/or sensor and alignment aids 30, as described in connection with FIGS. 2-8. These measurements of relative position between vehicle 12 and transmitter 32 may be correlated with contemporaneous wireless power transfer efficiency measurements and used in maintaining an accurate history. This history (sometimes referred to as historical vehicle-to-wireless-power-transmitter alignment information) may include, for each parking event, a record of wireless power transfer efficiency data and corresponding sensor data. By processing this data, the optimum location (as determined by sensor measurements) for parking vehicle 12 in space 14 can be identified. The sensor-determined optimal location may then be used in place of the nominal (pre-trial-and-error) optimal location.

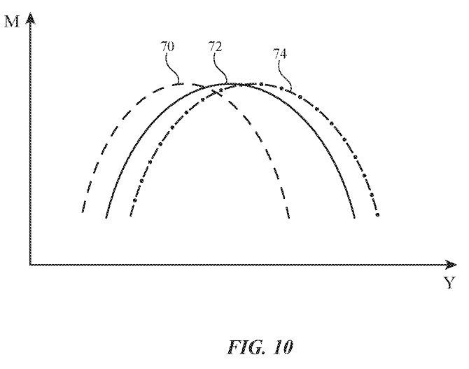

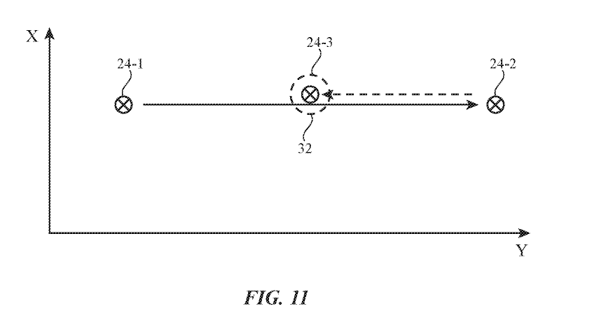

Consider, as an example, the graph of FIG. 10. In the graph of FIG. 10, wireless power efficiency (curve 72) has been plotted as a function of different longitudinal positions Y. Data for curve 72 may be acquired as vehicle 12 is being parked within a parking space and/or may be acquired over time (over multiple parking events). As shown by curve 72, wireless power transfer efficiency is initially low when receiver 24 is not yet sufficiently close to transmitter 32, peaks as receiver 24 passes over transmitter 32, then decreases again as receiver 24 moves away from transmitter 32.

As wireless power transfer efficiency data (curve 72) is being measured using the wireless power transfer equipment of system 10, control circuitry 18 may also use the sensors and alignment systems of system 10 to gather associated information on the position of vehicle 12 relative to transmitter 32. As an example a first sensor may gather sensor data corresponding to curve 70 and a second sensor may gather sensor data corresponding to curve 74. The sensor data that is gathered is responsive to the movement of vehicle 12. For example, sensor output indicative of alignment between receiver 24 and transmitter 32 may rise and fall as vehicle 12 passes transmitter 32. Nevertheless, curves 70 and 74 will not generally perfectly match curve 72 due to manufacturing variations. By correlating sensor measurements with corresponding measured wireless power transfer efficiency, the output of the sensors can be correlated to wireless power transfer efficiency so that vehicle 12 can rely on future sensor measurements in aligning vehicle 12 to transmitter 32.

In general, data may be gathered using any suitable number of sensors (e.g., 1-3, 1-10, more than 2, more than 4, more than 6, fewer than 50, etc.). By maintaining a history of information such as sensor curves 70 and 74 and power transfer efficiency curve 72 for each parking space 14 (or a set of discrete points associated with such curves), vehicle 12 may build a database (historical vehicle-to-wireless-power-transmitter alignment information) that correlates sensor measurements at each parking space 14 to sensor measurements made at that parking space. In this way, sensor measurements that will correspond to optimal alignment and peak power transfer efficiency can be identified and used in future parking events (e.g., sensor measurements for use by vehicle 12 in autonomously positioning vehicle 12 in parking space 14 for optimal alignment and power transfer efficiency may be identified).

Vehicle 12 may gather historical vehicle-to-wireless-power-transmitter alignment information for a single parking space 14 or may gather this information for each of multiple different parking spaces 14. Parking spaces may be identified by unique markings, by unique wireless identifier information (e.g., parking space identifiers that are communicated to vehicle 12 wirelessly during parking), or using other suitable identification techniques. When vehicle 12 approaches a parking space, circuitry 18 can query the parking space for its identifier and can use this information to access associated historical vehicle-to-wireless-power-transmitter alignment information for that parking space. Vehicle 12 may then use this historical information to park vehicle 12 in optimal alignment with the wireless transmitter in the parking space.

During a given parking event, vehicle 12 may move only in the forward (+Y) direction until reaching a desired position within parking space 14 or may move forward (past the peak wireless power efficiency location) and then backward (e.g., to the peak wireless power efficiency location). By moving past the peak location, vehicle 12 may be able to use the measurement of the peak location in determine an optimal position for vehicle 12. FIG. 11 shows how vehicle 12 may move so that receiver 24 is initially in location 24-1, moves past transmitter 32 to location 24-2, and then moves back in reverse to location 24-3 in alignment with transmitter 32. If desired, vehicle 12 may perform more back and forth maneuvers. Movements of the type shown in FIG. 11 and/or other search operations may be performed as part of a fine-tuning operation during a parking event or as part of a trial-and-error search for an optimum wireless power transfer efficiency location that is being performed during parking operations).

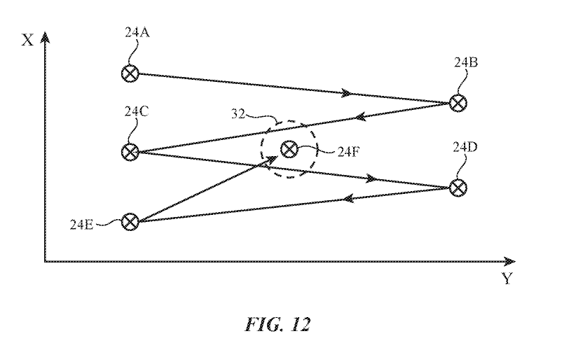

FIG. 12 shows how vehicle 12 may be moved in a two-dimensional search path by control circuitry 18 (e.g., a search path that causes receiver 24 to be positioned at a variety of different X and Y locations within parking space 14). For example, control circuitry 18 may use vehicle steering and propulsion system 22 to position receiver 24 at successive locations 24A, 24B, 24C, 24D, and 24E relative to transmitter 32, while gathering sensor data and wireless power transfer efficiency data. The gathered data may then be processes to updated historical alignment information and/or to help determine that receiver 24 should be moved to optimal location 24F. This type of two-dimensional mapping operation may be performed each time vehicle 12 is parked (e.g., to supplement historical vehicle-to-wireless-power-transmitter alignment information) or may be performed mostly during early “learning” phases of operation.

As the example of FIG. 12 illustrates, it may be desirable for vehicle 12 to explore a variety of different positions within parking space 14 to ensure that an optimal location of vehicle 12 and receiver 24 is identified. To avoid or reduce the amount of two-dimensional maneuvering that is involved during each parking event, vehicle 12 can perform trial-and-error data gathering operations over a series of multiple parking events.

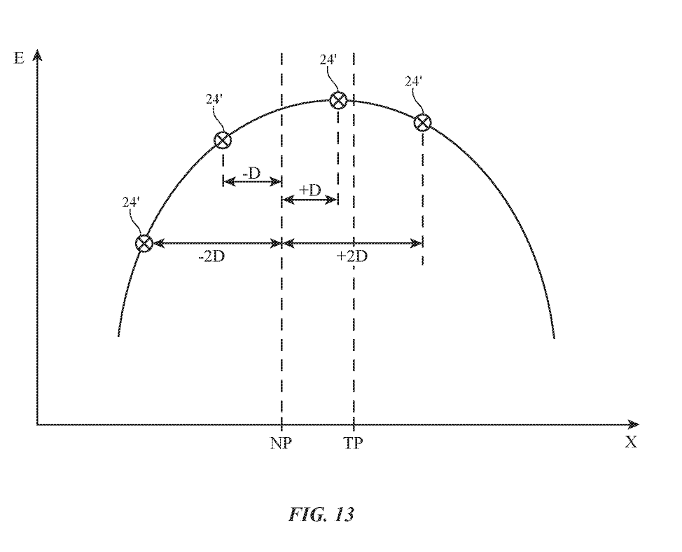

Consider, as an example, the scenario of FIG. 13. With this scenario, vehicle 12 is being parked at various unique positions within parking space 14 over a period of time, so that receiver 24 is aligned in a variety of respective unique positions with respect to transmitter 24. Vehicle 12 may, for example, intentionally misalign receiver 24 with respect to transmitter 24. In the FIG. 13 example, vehicle 12 is initially informed (e.g., by information stored in vehicle 12 during manufacturing) that location NP is the nominal optimal position for placing vehicle 12 in parking space 14 so that transmitter 24 and receiver 32 are aligned. To explore the possibility that location NP is not actually the best location for vehicle 12, vehicle 12 can park in positions where receiver 24 is intentionally misaligned with respect to position NP such as positions 24′ (as determined by sensor measurements). In the illustrative scenario of FIG. 13, positions 24′ are dithered to the left and right (−X and +X) directions relative to nominal optimal position NP (e.g., by distances −D, +D, −2D, +2D, etc.). The value of intentional misalignment step size D may be 1-5 cm, 1-50 cm, 0.5-10 cm, more than 0.4 cm, more than 2 cm, more than 5 cm, less than 100 cm, less than 10 cm, or other suitable size. Positions 24′ may be misaligned in the X dimension, Y dimension, and/or both the X and Y dimensions with respect to nominal location NP. Approaches in which the vertical (Z) location of receiver 24 is adjusted may also be used. The example of FIG. 13 in which positions 24′ are misaligned in dimension X is merely illustrative. If desired, measurements may also be taken at the location (as indicated by sensor data) where receiver 24 is aligned with nominal optimal position NP.

If desired, vehicle 14 may perform each of the intentional misalignments of receiver 24 relative to transmitter 32 over a series of respective parking events. For example, to gather 20 data points (measurements of wireless power transfer efficiency and corresponding sensor measurements) with which to update the historical vehicle-to-wireless-power-transmitter alignment information using an arrangement of the type shown in FIG. 13, vehicle 20 can park in 20 corresponding unique locations 24′ over a series of 20 respective parking events. If, for example, vehicle 12 parks in parking space 14 once per day, 20 separate measurements (or 20 series of measurements) of wireless power transfer efficiency and sensor data could be made over each of 20 separate days. If, for example vehicle 12 parks in parking space 14 until its battery has been recharged sufficiently, 20 separate measurements (or 20 series of measurements) of wireless power transfer efficiency and sensor data could be made over each of the charging sessions. With this approach, transmitter 24 may be somewhat misaligned with respect to transmitter 32 during the first 20 parking events, but, following processing of the gathered data, vehicle 12 can thereafter parking in the true optimal charging location (e.g., a location such as location TP of FIG. 13 in which wireless power transmission efficiency is optimized). Location TP may differ from the originally expected optimum location (nominal optimal position NP).

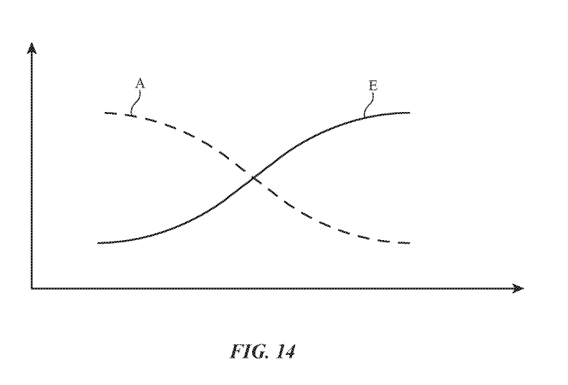

The characteristics of vehicle 12 and parking space 14 that affect wireless charging alignment may change relatively slowly. As a result, it may be desirable to implement an alignment optimization scheme that initially is fairly aggressive in mapping out different potential positions 24′ and that over time becomes less aggressive. As shown in the graph of FIG. 14, for example, as vehicle 12 performs sensor and wireless charging efficiency measurements over a series of parking events (increasing time t), the aggressiveness (A) with which control circuitry 18 directs vehicle steering and propulsion system 22 to position vehicle 12 may be decreased. For example, the number of dithered (intentionally misaligned) locations with respect to nominal position NP may be decreased (e.g., step size D may be decreased, the number of intentionally misaligned locations at which vehicle 12 is parked may be decreased, etc.), the number of times that vehicle 12 uses a full search path such as two-dimensional search path 12 of FIG. 12 when parking, and/or the aggressiveness with which vehicle 12 otherwise pursues identification of the true optimum wireless charging position for vehicle 12 may be decreased. As time progresses, vehicle 12 effectively learns the correct optimum location for vehicle 12 and the wireless power transfer efficiency E that can be achieved will increase accordingly.

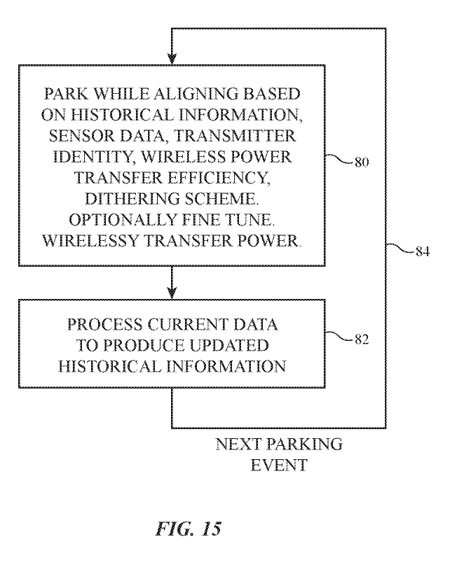

Illustrative operations involved in using system 10 to identify and optimum wireless charging location at which to park vehicle 12 within parking space 14 are shown in the flow chart of FIG. 15.

During the operations of block 80, vehicle 12 can park within parking space 14 based at least partly on historical vehicle-to-wireless-power-transmitter alignment information. During parking, vehicle 12 can make sensor measurements (e.g., camera measurements, LIDAR measurements, RADAR measurements, acoustic measurements, magnetic sensor measurements, foreign object detection coil measurements, impedance measurements and other measurements associated with the operations of transmitter 32 and receiver 24, mechanical sensor measurements, and other sensor measurements). Vehicle 12 can also make corresponding measurements of the wireless power transfer efficiency for system 10 (the efficiency with which wireless power transmitter 32 transfers power to receiver 24). After making one or more sensor measurements and one or more corresponding measurements of wireless power transfer efficiency for a given parking space, given parking location within the parking space, and given parking event, vehicle 12 may optionally use a search path such as the search path of FIG. 12 to fine tune the location of vehicle 12. If desired, this fine tuning step may be omitted to avoid the need to move vehicle 12 excessively once vehicle 12 has entered parking space 14. Search paths such as the search paths of FIGS. 11 and 12 may be used while making sensor measurements and wireless power transfer efficiency measurements during the parking of vehicle 12 or vehicle 12 may park at a desired location without reversing.

After gathering sensor measurements and wireless power transfer efficiency readings, processing may pass to block 82. During the operations of block 82, the gathered sensor measurements and gathered wireless power transfer efficiency data can be used in updating the historical vehicle-to-wireless-power-transmitter alignment information (e.g., running averages can be updated, a table of sensor readings and corresponding wireless power transfer efficiency measurements can be updated, etc.). Processing may then loop back to step 80 as indicated by line 84, where this historical information can be used by vehicle 12 in determining an optimum position for vehicle 12 relative to transmitter 32 in a subsequent parking event for parking space 14.

At least initially, while vehicle 12 is still aggressively learning how best to position vehicle 12 in parking space 14, vehicle 12 may vary the parking location of vehicle 12 around a known position (e.g., a nominal position that is initially thought to be an optimal location for wireless power transfer or the current best known position as determined from the historical alignment information). These intentional misalignment operations may take place over a series of parking events (a series of loops through the operations of blocks 80 and 82). During each parking event, vehicle 12 enters parking space 14 after traveling to and from a remote location. Once learning is complete, the process of entering and parking in parking space 14 (the operations of step 80) may be performed based on the historical alignment information that has been gathered during previous parking events.

With the arrangement of FIG. 15, control circuitry 18 of vehicle 12 can use steering and propulsion system 22 to align wireless power receiver 24 with wireless power transmitter 32 by positioning vehicle body 37 within parking space 14 based at least partly on historical vehicle-to-wireless-power-transmitter alignment information associated with previous positioning of the vehicle body within the parking space (e.g., during one or more previous parking events) while measuring wireless power transfer efficiency information associated with transmitting the wireless power from wireless power transmitter 32 to wireless power receiver 24 (e.g., to use in updating the historical alignment information for use in future parking events).

The operations of vehicle 12 and the operations of the equipment of parking space 14 (e.g., the operations of FIG. 15) may be performed by control circuitry 18 and/or 28. During operation, this control circuitry (which may sometimes be referred to as processing circuitry, processing and storage, computing equipment, a computer, etc.) may be configured to perform the method of FIG. 15 (e.g., using dedicated hardware and/or using software code running on hardware in system 10 such as control circuitry 18 and/or 28). The software code for performing these methods, which may sometimes be referred to as program instructions, code, data, instructions, or software, may be stored on non-transitory (tangible) computer readable storage media in control circuitry 18 and/or 28 such as read-only memory, random-access memory, hard drive storage, flash drive storage, removable storage medium, or other computer-readable media and may be executed on processing circuitry such as microprocessors and/or application-specific integrated circuits with processing circuits in control circuitry 18 and/or 28.

In accordance with an embodiment, a vehicle operable to receive wireless power from a wireless power transmitter associated with a parking space is provided that includes a vehicle body, a wireless power receiver coupled to the vehicle body, a steering and propulsion system coupled to the vehicle body, and control circuitry configured to use the steering and propulsion system to align the wireless power receiver with the wireless power transmitter by positioning the vehicle body within the parking space based at least partly on historical vehicle-to-wireless-power-transmitter alignment information associated with previous positioning of the vehicle body within the parking space and measuring wireless power transfer efficiency information associated with transmitting the wireless power from the wireless power transmitter to the wireless power receiver while using the steering and propulsion system to align the wireless power receiver with the wireless power transmitter.

In accordance with another embodiment, the control circuitry is further configured to update the historical vehicle-to-wireless-power-transmitter alignment information using the measured wireless power transfer efficiency information.

In accordance with another embodiment, the vehicle includes at least one sensor, the control circuitry is further configured to gather sensor information with the sensor while using the steering and propulsion system to align the wireless power receiver with the wireless power transmitter.

In accordance with another embodiment, the control circuitry is configured to update the historical vehicle-to-wireless-power-transmitter alignment information using the sensor information.

In accordance with another embodiment, the at least one sensor includes a foreign object detection coil array.

In accordance with another embodiment, the steering and propulsion system includes a component selected from the group consisting of a wheel speed sensor, an inertial measurement unit, a Doppler velocity sensor, and a satellite navigation system receiver.

In accordance with another embodiment, the at least one sensor includes a sensor selected from the group consisting of a camera, a magnetic sensor, a microphone, a light sensor, a radio-frequency receiver, and a mechanical sensor.

In accordance with an embodiment, a vehicle operable to receive wireless power from a wireless power transmitter that is located at a parking space is provided that includes a vehicle body, a wireless power receiver coupled to the vehicle body, a steering and propulsion system coupled to the vehicle body, at least one sensor, and control circuitry configured to, use the steering and propulsion system to position the vehicle body within the parking space where the wireless power receiver receives the wireless power from the wireless power transmitter, and update historical vehicle-to-wireless-power-transmitter alignment information based at least partly on sensor measurements gathered by the at least one sensor while the steering and propulsion system positions the vehicle body within the parking space.

In accordance with another embodiment, the control circuitry is further configured to gather wireless power transfer efficiency information associated with transmitting wireless power from the wireless power transmitter to the wireless power receiver while the steering and propulsion system positions the vehicle body within the parking space.

In accordance with another embodiment, the control circuitry is further configured to update the historical vehicle-to-wireless-power-transmitter alignment information based at least partly on the gathered wireless power transfer efficiency information.

In accordance with another embodiment, the at least one sensor includes a sensor selected from the group consisting of a foreign object detection coil array, a magnetic sensor that includes at least one power transfer coil, a light sensor, a radio-frequency signal detector, a microphone, a visible light camera, an infrared camera, and a mechanical sensor.

In accordance with an embodiment, a vehicle operable to receive wireless power from a wireless power transmitter in a parking space is provided that includes a vehicle body, a wireless power receiver coupled to the body, a steering and propulsion system coupled to the body, and control circuitry configured to repeatedly use the steering and propulsion system to position the vehicle body within the parking space during a plurality of respective parking events each of which involves parking the vehicle body at a unique location that differs from a nominally optimal location to receive wireless power with the wireless power receiver from the wireless power transmitter.

In accordance with another embodiment, there is a wireless power transfer efficiency associated with transmitting the wireless power from the wireless power transmitter to the wireless power receiver and the control circuitry is further configured to gather at least one measurement of the wireless power transfer efficiency for each of the parking events.

In accordance with another embodiment, the control circuitry is configured to use the steering and propulsion system to move the vehicle back and forth in the parking space during at least one of the parking events.

In accordance with another embodiment, the vehicle includes at least one sensor, the control circuitry is configured to gather at least one sensor measurement with the sensor for each parking event when the vehicle body is parked at the unique location for that parking event.

In accordance with another embodiment, the at least one sensor includes visible light camera.

In accordance with another embodiment, the at least one sensor includes an infrared light camera.

In accordance with another embodiment, the at least one sensor includes a foreign object detection sensor.

In accordance with another embodiment, the foreign object detection sensor includes an array of foreign object detection coils.

In accordance with another embodiment, the at least one sensor includes a sensor selected from the group consisting of a light sensor, a radio-frequency receiver, and a microphone.

The foregoing is merely illustrative and various modifications can be made to the described embodiments. The foregoing embodiments may be implemented individually or in any combination.

What is claimed is:

1. A vehicle operable to receive wireless power from a wireless power transmitter associated with a parking space, comprising:
a vehicle body;
a wireless power receiver coupled to the vehicle body;
a steering and propulsion system coupled to the vehicle body; and
control circuitry configured to:
use the steering and propulsion system to align the wireless power receiver with the wireless power transmitter by positioning the vehicle body within the parking space based at least partly on historical vehicle-to-wireless-power-transmitter alignment information associated with previous positioning of the vehicle body within the parking space; and
measure wireless power transfer efficiency information associated with receiving the wireless power from the wireless power transmitter while using the steering and propulsion system to align the wireless power receiver with the wireless power transmitter.

2. The vehicle of claim 1 wherein the control circuitry is further configured to update the historical vehicle-to-wireless-power-transmitter alignment information using the measured wireless power transfer efficiency information.

3. The vehicle of claim 2 further comprising at least one sensor, wherein the control circuitry is further configured to gather sensor information with the sensor while using the steering and propulsion system to align the wireless power receiver with the wireless power transmitter.

4. The vehicle of claim 3 wherein the control circuitry is configured to update the historical vehicle-to-wireless-power-transmitter alignment information using the sensor information.

5. The vehicle of claim 4 wherein the at least one sensor comprises a foreign object detection coil array.

6. The vehicle of claim 4 wherein the at least one sensor comprises a light detection and ranging system.

7. The vehicle of claim 4 wherein the at least one sensor comprises an image sensor.

8. The vehicle of claim 4 wherein the steering and propulsion system includes a component selected from the group consisting of: an inertial measurement unit and a Doppler velocity sensor.

9. The vehicle of claim 4 wherein the at least one sensor comprises a sensor selected from the group consisting of: a magnetic sensor, a microphone, and a radio-frequency receiver.

10. The vehicle of claim 3 wherein the historical vehicle-to-wireless-power-transmitter alignment information comprises wireless power transfer efficiency information and offset information representing a distance between (i) the vehicle at a time of measuring the wireless power transfer efficiency information and (ii) a geographic coordinate of a location of the parking space.

11. A vehicle operable to receive wireless power from a wireless power transmitter that is located at a parking space, comprising:
a vehicle body;
a wireless power receiver coupled to the vehicle body;
a steering and propulsion system coupled to the vehicle body;
at least one sensor; and
control circuitry configured to:
use the steering and propulsion system to position the vehicle body within the parking space where the wireless power receiver receives the wireless power from the wireless power transmitter; and
update historical vehicle-to-wireless-power-transmitter alignment information based at least partly on sensor measurements gathered by the at least one sensor while the steering and propulsion system positions the vehicle body within the parking space.

12. The vehicle of claim 11 wherein the control circuitry is further configured to:
gather wireless power transfer efficiency information associated with transmitting wireless power from the wireless power transmitter to the wireless power receiver while the steering and propulsion system positions the vehicle body within the parking space.

13. The vehicle of claim 12 wherein the control circuitry is further configured to:
update the historical vehicle-to-wireless-power-transmitter alignment information based at least partly on the gathered wireless power transfer efficiency information.

14. The vehicle of claim 11 wherein the control circuitry is further configured to:
use the steering and propulsion system to position the vehicle body within the parking space based at least partly on the historical vehicle-to-wireless-power-transmitter alignment information.

15. The vehicle of claim 11 wherein the at least one sensor comprises a sensor selected from the group consisting of: a foreign object detection coil array, a light detection and ranging system, and an image sensor.

16. A vehicle operable to receive wireless power from a wireless power transmitter in a parking space, comprising:
a vehicle body;
a wireless power receiver coupled to the body;
a steering and propulsion system coupled to the body; and
control circuitry configured to repeatedly use the steering and propulsion system to position the vehicle body within the parking space during a plurality of respective parking events each of which involves parking the vehicle body at a unique location that differs from a nominally optimal location to receive wireless power with the wireless power receiver from the wireless power transmitter.

17. The vehicle of claim 16 wherein the control circuitry is configured to use the steering and propulsion system to move the vehicle back and forth in the parking space during at least one of the parking events.

18. The vehicle of claim 17 further comprising at least one sensor, wherein the control circuitry is configured to gather at least one sensor measurement with the sensor for each parking event when the vehicle body is parked at the unique location for that parking event.

19. The vehicle of claim 18 wherein the at least one sensor comprises visible light camera.

20. The vehicle of claim 18 wherein the at least one sensor comprises a foreign object detection sensor.

21. The vehicle of claim 18 wherein the at least one sensor comprises a light detection and ranging system.

22. The vehicle of claim 16 wherein there is a wireless power transfer efficiency associated with transmitting the wireless power from the wireless power transmitter to the wireless power receiver and wherein the control circuitry is further configured to:
gather at least one measurement of the wireless power transfer efficiency for each of the parking events.
